(19) United States
(12) Patent Application Publication
(10) Pub. No.: US 2026/0261021 A1
(43) Pub. Date: Sep. 3, 2026

(54) Electric Energy Storage Device for a Motor Vehicle, in Particular for an Automobile, and Motor Vehicle

(71) Applicant: Bayerische Motoren Werke Aktiengesellschaft, Muenchen (DE)

(72) Inventors: Franz FUCHS, Muenchen (DE); Sascha ZIMMERMANN, Muenchen (DE)

(21) Appl. No.: 19/159,752

(22) PCT Filed: May 7, 2024
(86) PCT No.: PCT/EP2024/062548

§ 371 Date: Aug. 26, 2025

(30) Foreign Application Priority Data
Jun. 5, 2023 (DE) 10 2023 114 660.2

(51) Int. Cl. H01M 50/583; H01M 10/653; H01M 50/213; H01M 50/249; H01M 50/293; H01M 50/503; H01M 50/543

(52) U.S. Cl. CPC H01M 50/583; H01M 10/653; H01M 50/213; H01M 50/249; H01M 50/293; H01M 50/503; H01M 50/543; H01M 2220/20

(57) ABSTRACT

An electric energy storage device for a motor vehicle has a storage housing that defines a receiving space, and storage cells, which are arranged in the receiving space, designed to store electric energy and which each have a cell housing and at least one terminal element to which a connection element of a connection device arranged in the receiving space is assigned. The connection element assigned to the terminal element has a fuse and is electrically connected to the terminal element to which the connection element is assigned, as a result of which terminal elements are electrically connected to one another via the connection device. A foam, which connects the storage cells to one another and/or to the storage housing, is arranged in the receiving space.

### BACKGROUND AND SUMMARY

The invention relates to an electrical energy storage device for a motor vehicle, in particular for an automobile. Further, the invention relates to a motor vehicle with at least one such electrical energy storage device.

DE 10 2021 112 889 A1 discloses a cell connector for connecting cell terminals. At least one connecting element made of an electrically conductive material is envisaged, which has two connection areas and a fuse area arranged between the connection areas, which has an area with a reduced cross-section and is thus in particular in the form of a fuse.

The object of the present invention is to create an electrical energy storage device for a motor vehicle, as well as a motor vehicle with at least one such electrical energy storage device, so that particularly safe and secure operation can be realized.

This object is achieved according to the invention by an electrical energy storage device for a motor vehicle and by a motor vehicle with the features of the independent claims. Advantageous embodiments of the invention are the subject of the dependent claims.

A first aspect of the invention relates to an electrical energy storage device, which is also referred to as simply an energy storage device, for a motor vehicle which is also referred to simply as a vehicle. This means that the motor vehicle, which is preferably in the form of an automobile, in particular of a passenger car, has the electrical energy storage device in the fully manufactured state, by means of or in which electrical energy is to be stored or is stored, in particular electrochemically. Preferably, the electrical energy storage device is a high-voltage component, the electrical voltage of which, in particular the electrical operating or nominal voltage, is preferably greater than 50 volts, especially greater than 60 volts, and most preferably several hundred volts. The electrical energy storage device is also referred to as a battery and is in particular a secondary battery, wherein the electrical energy storage device is also referred to as a high-voltage battery (HV battery), especially if the electrical energy storage device is a high-voltage component.

The electrical energy storage device has a storage housing, which bounds a receiving space, especially directly. In particular, the receiving space is bounded, especially directly, by an inner circumferential sheath surface of the storage housing. The electrical energy storage device also has a plurality of storage cells arranged in the receiving space and thus in the storage housing, by means of or in which the aforementioned electrical energy is to be stored or is stored, in particular electrochemically. The storage cells are also simply referred to as cells and are cells formed separately from each other and separately from the storage housing, and are also referred to as single cells. The respective storage cell has a respective cell housing and at least one respective terminal element, which is also referred to as a terminal. The respective terminal element is also referred to as the respective first terminal element. When the respective terminal element is referred to above and below, this is to be understood, unless otherwise stated, as the respective first terminal element of the respective storage cell. For example, the respective storage cell has at least two or exactly two terminal elements, also known as terminals, namely the aforementioned first terminal element and a second terminal element. The respective storage cell can provide the electrical energy stored by the respective storage cell via the respective terminal element. In addition, electrical energy, which is provided or can be made available, for example, by an electric machine of the motor vehicle, can be supplied via the respective terminal element to the respective storage cell and stored in the respective storage cell, i.e. saved in the respective storage cell.

The electrical energy storage device also has a connecting device arranged in the receiving space, which is formed separately from the storage housing and separately from the storage cells and thus separately from the terminal elements. A respective connecting element of the connecting device is assigned to the respective terminal element. The connecting device is also known as a cell contactor system, cell contacting system or ZKS. For example, the respective terminal element is arranged on a respective housing side of the respective cell housing of the respective storage cell, wherein it is particularly conctemplated that the respective terminal element protrudes from the respective cell housing of the respective storage cell, in particular along or in an extension direction, so that, for example, the respective connecting element is raised relative to the respective cell housing, i.e. relative to the respective sub-areas of the respective cell housing directly adjacent to the respective terminal element.

The respective connecting element of the connecting device assigned to the respective terminal element is electrically and preferably also mechanically connected to the respective terminal element to which the respective connecting element is assigned. Since the respective connecting element assigned to the respective terminal element is assigned to the respective terminal element, conversely the respective terminal element to which the respective connecting element is assigned, is assigned to the respective connecting element that is assigned to the respective terminal element. Because the respective connecting element is electrically connected to the respective assigned terminal element, the terminal elements and thus the storage cells are electrically connected to each other via the connecting device, whereby, for example, the storage cells or the terminal elements are connected to each other in series or in parallel. For example, the respective connecting element is connected electrically and preferably also mechanically to the respective assigned terminal element in such a way that the respective connecting element is materially connected to the respective assigned terminal element. For this purpose, for example, the respective connecting element is welded to the respective assigned terminal element, in particular by laser welding.

The respective connecting element assigned to the respective terminal element has a respective fuse. Since the respective connecting element is assigned to the respective terminal element, and the respective connecting element assigned to the respective terminal element has the respective fuse, the respective fuse of the respective connecting element, which is assigned to the respective terminal element, is assigned to the respective terminal element to which the respective connecting element is assigned and vice versa. The respective fuse is a respective fuse area of the respective connecting element. As described, for example, in DE 102021 112 889 A1 , the respective fuse is formed by an, in particular, local cross-section tapering or cross-section reduction of the respective connecting element, so that, for example, the respective fuse of the respective connecting element has a smaller cross-section than the sub-areas of the respective connecting element that are directly connected to the respective fuse of the respective connecting element on both sides. In particular, the respective connecting element and thus the respective fuse and the respective sub-areas of the respective connecting element are made of an electrically conductive and, for example, metallic material such as copper or aluminum. The following can happen as a result of the described cross-sectional reduction or cross-sectional tapering of the fuse, i.e. because the fuse has a smaller cross-section than the aforementioned sub-areas of the respective connecting element: If, for example, as a result of a thermal event of one of the storage cells, an electric current, also known as a residual current, passes through the connecting element which is assigned to the terminal element of the one storage cell which has the thermal event, wherein the electric current exceeds a limit value that in particular can be specified or predetermined, then there is such strong heating of the connecting element assigned to the terminal element of the one storage cell that has the thermal event that the fuse of the connecting element of the one storage cell melts and thus fails. This is also known as tripping of the fuse. In other words, the fuse of the connecting element assigned to the terminal element of the one storage cell at or in which the thermal event occurred triggers. By triggering the fuse, the one storage cell is electrically or galvanically isolated from the other, remaining storage cells, so that, for example, the thermal event of one storage cell spreading to the other storage cells and thus a so-called thermal propagation can be avoided. The aforementioned limit value can be designed, i.e. defined, for example, by the design of the respective fuse, in particular with regard to the material from which the respective connecting element is formed and/or by the respective cross-section of the respective fuse.

In order to be able to realize a particularly advantageous, in particular particularly safe, operation of the electrical energy storage device, it is provided according to the invention that a foam, which is formed separately from the storage cells and separately from the connecting device, and which is in particular in the form of a structural foam, is arranged in the receiving space. The foam is also referred to as the first foam. When the foam is referred to above and below, then unless stated otherwise it is to be understood as the first foam. For example, the first foam is a polyurethane foam (PU foam). By means of the foam, the storage cells are connected, in particular glued, to each other and/or to the storage housing. Furthermore, the following is contemplated: The storage housing can have at least two or exactly two separately formed and mutually connected housing parts. For example, a first of the housing parts is an upper part of the housing, wherein, for example, a second of the parts of the housing is a lower housing part. In the installation position of the electrical energy storage device, the housing parts may be arranged one after the other in the vehicle vertical direction of the motor vehicle and thus one on top of the other, wherein the electrical energy storage device occupies its installation position in the fully manufactured state of the motor vehicle having the electrical energy storage device. The housing parts may be connected to each other by means of the foam, in particular glued to each other. This is done, for example, in such a way that the foam rests on both parts of the housing, especially directly in each case. Furthermore, the foam may be in direct contact with the respective cell housing, in particular to a respective outer circumferential sheath surface of the respective cell housing, whereby, for example, the cell housing and thus the storage cells are connected to each other by means of the foam, in particular glued to each other. Furthermore, the foam may be in contact, in particular directly, with the storage housing and, in particular, directly with the respective cell housing, in particular with the respective outer circumferential sheath surface of the respective cell housing, whereby, for example, the respective storage cell is connected to the storage housing, in particular glued. The foam can be used to avoid unwanted, excessive relative movements between the storage cells and/or between the respective storage cell and the storage housing. In addition, the foam can be used to transfer loads such as forces particularly advantageously between the storage cells and/or between the respective storage cell and the storage housing and/or between the housing parts, whereby particularly high robustness and thus a particularly high level of safety of the electrical energy storage device can be demonstrated.

Furthermore, according to the invention, it is provided that the respective fuse of the respective connecting element assigned to the respective terminal element is assigned a boundary element that is preferably separate from the storage cells, separate from the connecting device and separate from the storage housing, and also separate from the foam and provided in addition to the foam, which is most preferably in the form of a solid body. The respective boundary element can be made of a metallic material or of a plastic. A respective volume is bounded, in particular directly and/or at least partially, by the respective boundary element assigned to the respective fuse, wherein the respective fuse, to which the respective boundary element is assigned, is overlapped by the respective volume on a respective side, which is also referred to as the fuse side, facing away from the respective cell housing of the respective storage cell, which has the respective terminal element to which the respective connecting element is assigned, which has the respective fuse, to which the respective boundary element is assigned and in particular facing towards the storage housing, in particular towards one of the housing parts. Where reference is made to the side above and below, it is to be understood as the respective fuse side, unless stated otherwise. The respective volume is free of the foam. This means that the boundary element keeps the volume free of the foam, especially if, for example, the foam, especially in the liquid state of the foam, or a starting material from which the foam is formed or arises, in particular in the liquid state of the starting material, is introduced into the receiving space. As a result, the respective volume is free of the foam in the fully produced state, i.e. in the fully produced state of the electrical energy storage device, the foam is not arranged in the respective volume. The fact that the respective volume is free of the foam avoids excessive, undesirable heat dissipation from the respective fuse, and, for example, enables particularly advantageous thermal insulation of the respective fuse to be realized, so that excessive, undesirable heat dissipation from the respective fuse can be avoided. In other words, for example, by not using the boundary elements and thus not keeping the volumes free of the foam, the foam would be directly in contact with the respective fuse, wherein for example, excessive heat could be dissipated from the respective fuse into the foam.

Although the foam can have particularly advantageous mechanical properties and thus provide particularly advantageous mechanical properties of the energy storage system, these advantageous mechanical properties of the foam can be combined with an undesirable high thermal conductivity and/or an undesirable high thermal capacity of the foam, so that a lot of heat would be dissipated from the respective storage cell if the foam were directly in contact with the respective fuse. On the one hand, the invention makes it possible to use the foam to create an advantageously high, especially mechanical, robustness of the energy storage system. On the other hand, the use of the boundary elements and the fact that the boundary elements keep the volumes free of the foam can avoid excessive heat dissipation from the fuses, since, for example, by means of the respective assigned boundary element and by means of the respective volume bounded by the respective boundary element, the respective fuse can be advantageously thermally insulated from the foam.

The invention is based in particular on the following findings and considerations: Due to effects, which will not be discussed in more detail here, an exothermic reaction can occur in the respective storage cell, also referred to as a battery cell and in the form, for example, of a lithium-ion cell. This can lead to conditions in which the respective storage cell is no longer in the form of or functions as a voltage source, but changes into a conductor with a defined electrical resistance, i.e. changes from a voltage source to a conductor with a defined resistance. For example, at least one of the effects is or includes a thermal event. If, for example, the storage cells are connected in a P-array, i.e. connected to each other in parallel, an electrical discharge of the other, remaining and not yet intact storage cells in this P-array can occur via the now conductive storage cell, which is thus in the form of a conductor with defined resistance. If no countermeasure is taken, the remaining storage cells that are still intact run the risk of overheating and going into a thermal event themselves, so that thermal propagation can occur.

The invention now makes it possible to avoid the previously mentioned problems and disadvantages. Consequently, the boundary elements and the resulting bounded volumes, which are free of the foam, are a countermeasure to avoid thermal propagation or at least to delay it in an advantageous way.

If, for example, there is a medium-impedance failure of one of the storage cells, it is usually not sufficient to trigger the fuse assigned to a storage cell purely by an electric current resulting from the medium-impedance failure, also known as a residual current, since the residual current occurring in such a medium-impedance failure, which flows through the connecting element assigned to the terminal element of the storage cell having the medium-impedance failure, may lie in the range of an electrical operating current that may occur during normal operation of the energy storage system in which there is no medium-impedance failure of a storage cell. In order to be able to electrically isolate this defective storage cell from the remaining, other and still intact storage cells in the event of such a medium-impedance failure of one of the storage cells, in such a way that the fuse of the connecting element assigned to the terminal element of the storage cell melts, i.e. triggers, a temperature-related, i.e. a temperature-triggered, tripping of the fuse of the connecting element assigned to the terminal element of the one storage cell is advantageous, so that the fuse is triggered, i.e. melted, by a combination of a high temperature of the fuse resulting from the medium-impedance failure and a residual current resulting from the medium-impedance failure.

A further background is in particular that in the event of a defect such as a medium-impedance failure of the respective storage cell, for example or possibly only a small electrical residual current, which passes or flows through the respective fuse of the respective connecting element and is not alone sufficient to melt the fuse, i.e. to trigger it, but, in particular, heating of the fuse also occurs, so that there is an increase in the temperature of the fuse, wherein this heating and thus this increase in temperature is not or not only caused by the residual current, but, in particular also, by another heating effect such as conduction, and wherein this other heating effect is due to the said defect and/or to a thermal event of the respective storage cell caused by or associated with the defect. The residual current, i.e. heating of the fuse caused by the residual current in combination with the other heating effect, now leads to melting and thus to tripping of the fuse, because by using the respective boundary element and by the respective boundary element keeping the volume free of the foam, the respective fuse is particularly advantageously thermally insulated from the foam.

For example, the connecting device is and/or the storage cells are embedded in the foam, which, as described above, can provide advantageous structural robustness of the energy storage system, but can have an excessively high thermal conductivity and/or an excessively high thermal capacity.

Thus, in the event of a medium-impedance failure of one of the storage cells, there could be an excessive, undesirable heat dissipation from the fuse of the connecting element assigned to the terminal element of the one storage cell, so that the one storage cell is defective, but the fuse of the connecting element assigned to the terminal element of the one storage cell does not melt. However, the invention now makes it possible that even in the event of a low-impedance or medium-impedance failure of the respective storage cell, melting, i.e. triggering, of the respective fuse of the respective connecting element assigned to the respective terminal element of the respective storage cell occurs, since because the respective fuse is advantageously thermally insulated from the or against the foam by means of the respective assigned boundary element and the resulting bounded volume, a medium-impedance failure of the respective storage cell leads to such an advantageous combination of the residual current flowing through the fuse and heating of the fuse that the respective fuse melts due to this combination and thus fails, i.e. is tripped. As a result, the respective storage cell is advantageously separated from the remaining, other and still intact storage cells, even in the event of a medium-impedance failure. In other words, because the respective fuse is thermally insulated from the foam by means of the respective boundary element and the resulting bounded volume, the combination of residual current and heating of the respective fuse is sufficient to trigger the respective fuse, thus causing it to melt and thus causing it to fail, whereby the respective storage cell is separated from the respective other, remaining and still intact storage cells.

In order to be able to thermally insulate the respective fuse from the respective foam in a particularly advantageous way by means of the respective boundary element and the resulting bounded volume, it is provided in an embodiment of the invention that the respective volume is filled with a respective medium, in particular completely, which has a lower thermal conductivity and/or a lower thermal capacity compared to the foam. This means that the foam has a first thermal conductivity and a first thermal capacity, wherein the medium has a second thermal conductivity and a second thermal capacity. Preferably, the second thermal conductivity is lower than the first thermal conductivity. Alternatively or additionally, the second thermal capacity is lower than the first thermal capacity.

Another embodiment is characterized in that the respective medium is a gas, which allows particularly advantageous thermal insulation to be realized.

It has proven to be particularly advantageous if the gas is air, which allows particularly advantageous thermal insulation of the respective fuse to be realized in a particularly weight-efficient and cost-effective way.

In another, particularly advantageous embodiment of the invention, it is provided that the boundary elements are formed separately from the storage housing and are connected, in particular directly, to the storage housing. This enables undesirable relative movements between the respective boundary element and the storage housing to be avoided, so that a defined and precise positioning of the respective boundary element and thus of the respective volume can be presented, especially relative to the respective fuse. As a result, particularly advantageous thermal insulation can be guaranteed. For example, the respective boundary element may be glued to the storage housing, especially directly. In particular, the respective volume may be bounded partly by the respective boundary element and partly by the storage housing, i.e. by a respective wall area of the respective storage housing, in particular directly in each case, whereby particularly advantageous thermal insulation can be presented.

In order to be able to precisely position the boundary elements and thus the volumes relative to the fuses and thus to be able to realize advantageous thermal insulation of the respective fuse, it is provided in a further embodiment of the invention that the boundary elements are formed separately from each other and connected to each other, or the boundary elements are formed in one piece with each other, i.e. formed from a single piece, so that, for example, the boundary elements are formed by a one-piece body, thus formed from a single piece and thus integrally produced, which is thus in the form of a monobloc. If the boundary elements are formed separately from each other and connected to each other, or if the boundary elements are formed together in one piece, then the boundary elements are formed by a single unit, which can be handled and installed easily and cost-effectively and precisely aligned relative to the fuses, so that particularly advantageous thermal insulation of the respective fuse can be presented.

For example, the boundary elements are formed by a plate in the form of a load distribution plate, so that, for example, the unit, especially the body, is the mentioned plate.

In a further, particularly advantageous embodiment of the invention, the respective terminal element to which the connecting element having the respective fuse is assigned is also at least partially overlapped, in particular towards the storage housing, on a side facing away from the respective cell housing and facing the respective fuse of the respective connecting element assigned to the respective terminal element, also referred to as the element side, so that even in the event of a low-impedance or medium-impedance failure of the respective storage cell, safe tripping of the respective fuse can be guaranteed. The respective fuse side and/or the respective element side is overlapped by the respective volume, in particular in the aforementioned extent direction, in which the respective connecting element is raised relative to the respective cell housing, so that particularly advantageous thermal insulation can be realized.

In another, particularly advantageous embodiment of the invention, it is envisaged that a respective side of the respective boundary element assigned to the respective fuse of the respective connecting element, also referred to as the boundary side, which is facing the respective connecting element, is directly connected, in particular glued, to the respective connecting element. Thus, preferably in particular along the direction of extension, no other, further component or medium is arranged between the respective connecting element and the respective boundary element, in particular the respective boundary side, in particular with the exception of a glue by means of which the boundary side is glued, in particular directly, to the respective connecting element, so that particularly advantageous thermal insulation can be presented.

Finally, it has proven to be particularly advantageous for the realization of a particularly advantageous thermal insulation of the respective fuse if the respective boundary side of the respective boundary element is glued directly to the respective connecting element by means of a glue that is different from the foam.

A second aspect of the invention relates to a motor vehicle which is simply also referred to as a vehicle and preferably in the form of an automobile, in particular of a passenger car, which has at least one electrical energy storage device according to the first aspect of the invention. Advantages and advantageous embodiments of the first aspect of the invention are to be regarded as advantages and advantageous embodiments of the second aspect of the invention and vice versa.

In particular, the invention is also based on the findings that conventional solutions provide for a complete foaming of all storage cells, including the terminal elements and the cell contact system, so that all storage cells, the terminal elements, and the cell contact system are embedded in the foam. For example, in order to arrange the foam in the receiving space, in particular to introduce it into the receiving space, the aforementioned starting material, for example, is introduced into the receiving space, especially in the liquid state of the starting material, whereupon the starting material, for example, swells or foams up and thus becomes the foam. As described above, the foam is used to create advantageous, especially mechanical, properties of the energy storage system, but the foam can lead to undesirable influences on the fuses due to its thermal properties, but this can now be avoided. In particular, the fuses can be thermally decoupled from the foam and also, for example, from the storage housing by the boundary elements and the resulting bounded volumes, so that safe implementation of the respective fuse can be guaranteed. The aforementioned component is, for example, an additional component that is formed separately from the storage cells, separately from the storage housing, separately from the foam and separately from the cell contacting system. The boundary elements or the component are or is, for example, arranged between the respective terminal element, in particular between the respective fuse, and one of the housing parts, in particular the upper housing part. For example, the component is connected to the one housing part, in particular glued, in a foam-tight way so that, for example, the foam cannot penetrate between the one housing part and the component and penetrate into the respective volume. Thus, the connection of the component to the one housing part prevents foam from penetrating into the volume.

The respective boundary element is, for example, a protrusion, also referred to as a bulge, which, for example, extends from respective parts of the unit, in particular directly adjacent to the respective boundary element, in particular towards the respective assigned fuse or the respective connecting element and also, for example, protrudes from the one housing part.

If, for example, a defect such as a thermal event occurs in one of the storage cells, resulting in heating of the fuse of the connecting element assigned to the terminal element of the one storage cell, heat is transferred from the fuse of the one storage cell to the boundary element assigned to this fuse, whereby, for example, the boundary element is at least partially melted or is molten. Since, for example, the volume bounded by the boundary element contains the aforementioned medium, in particular air, the fuse to which the molten boundary element is assigned is subsequently not, or is only very poorly, thermally connected to the storage housing and also to the foam, so that the fuse is particularly advantageously insulated from the storage housing and from the foam by the medium, so that excessive heat dissipation from the fuse can be avoided. As a result, the fuse melts due to the defect, causing the associated storage cell to be electrically or galvanically isolated from the other, still intact storage cells. As a result, a particularly high level of safety can be ensured.

The respective boundary element may be directly in contact with the respective fuse to which the respective boundary element is assigned. Furthermore, the respective boundary element fully or completely surrounds or encloses the respective fuse to which the respective terminal element is assigned, in particular the respective terminal element which has the respective fuse to which the respective boundary element is assigned, whereby particularly advantageous thermal insulation can be presented.

Further details of the invention can be found in the following description of a preferred exemplary embodiment with the associated drawings.

### BRIEF DESCRIPTION OF DRAWINGS

FIG. 1 is a schematic and sectional side view of an electrical energy storage device of a motor vehicle; and

FIG. 2 shows in sections a schematic and sectional plan view of the electrical energy storage device.

In the figures identical or functionally identical elements are provided with the same reference signs.

### DETAILED DESCRIPTION OF DRAWINGS

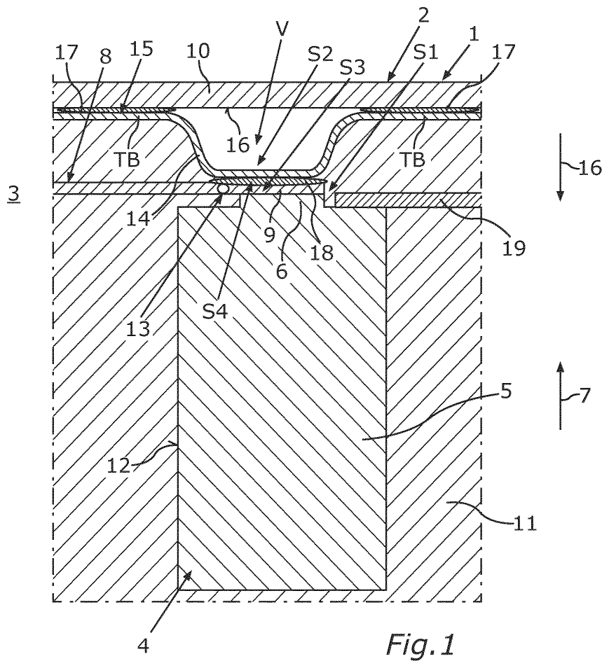

FIG. 1 shows a section in a schematic and sectional side view of an electrical energy storage device 1 for a motor vehicle, simply referred to as a vehicle. The electrical energy storage device 1 has a storage housing 2, which is shown in detail and in a particularly schematic way in FIG. 1, which bounds a receiving space 3, in particular directly. In the receiving space 3, several storage cells 4 of the electrical energy storage device 1 are arranged, wherein electrical energy is to be stored or is stored, in particular electrochemically, by means of the storage cells 4. The respective storage cell 4 has a respective cell housing 5 and at least one respective terminal element 6, also referred to as a terminal.

It can be seen from FIG. 1 that in the exemplary embodiment shown in FIG. 1, the respective terminal element 6 is arranged on a respective side S1 of the respective cell housing 5, also referred to as the cell side or cell housing side, and protrudes from the respective cell housing 5 along a direction of extension, i.e. it is raised relative to the respective cell housing 5. The direction of extension is illustrated in FIG. 1 by an arrow 7. In the installation position of the electrical energy storage device 1, for example, the direction of extension runs upwards in the vehicle upward direction of the motor vehicle. The respective storage cell 4 can provide the respective electrical energy stored in the respective storage cell 4 via the respective terminal element 6. In addition, for example, electrical energy that can be provided or is provided by an electric machine of the motor vehicle, for example, can be supplied to the respective storage cell 4 via the respective terminal element 6 and thus saved into the respective storage cell 4, i.e. is stored in the respective storage cell 4. In particular, the motor vehicle may be driven electrically, in particular solely, by means of the electric machine. If, for example, the storage cells 4 or terminal elements 6 are providing the electrical energy, the electric machine can be supplied with the electrical energy provided, whereby the electric machine can be operated in motor mode and thus as an electric motor. By means of the electric motor, the motor vehicle can be driven especially solely electrically. Preferably, the electric machine is a high-voltage component with an electrical voltage, in particular the operating or nominal electrical voltage, preferably greater than 50 volts, and in particular greater than 60 volts, and most preferably several hundred volts.

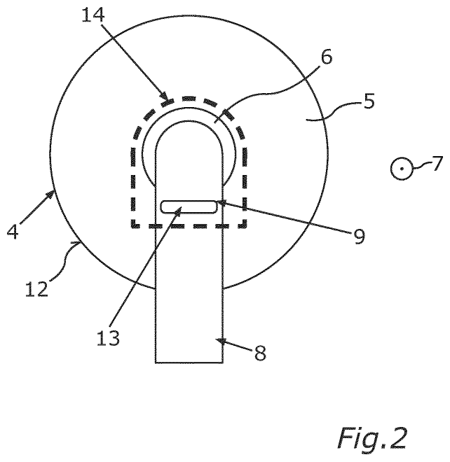

The energy storage system 1 also has a connecting device 8, which is also referred to as the cell contactor system, cell contacting system or CCS, arranged in the receiving space 3, which is formed separately from the storage cells 4 and separately from the storage housing 2. As can be seen in particular in conjunction with FIG. 2, a respective connecting element 9 of the connecting device 8 is assigned to the respective terminal element 6, wherein the respective connecting element 9 is also referred to as the cell connector. For example, the respective terminal element 6 forms a respective electrical positive pole of the respective storage cell 4. The respective connecting element 9 assigned to the respective terminal element 6 is electrically and preferably also mechanically connected to the respective terminal element 6, to which the respective connecting element 9 is assigned, whereby the terminal elements 6 are electrically connected to each other via the connecting device 8. As a result, the storage cells 4 are electrically connected to each other via the connecting device 8, whereby, for example, the storage cells 4 are connected to each other in series or in parallel. As a result, the storage cells 4, for example, form an array, which is formed as a P-array or is also referred to as a P-array, especially when the storage cells 4 are connected to each other in parallel.

For example, the storage housing 2 has at least two or exactly two housing parts, which can be formed separately from each other and connected to each other. One of the housing parts is recognizable in FIG. 1 and is labeled 10. For example, the housing part 10 is a housing upper part, also referred to as the upper part, wherein the other housing part that is not shown in the fig. contacts the upper housing part downwards in the vehicle vertical direction in the installation position of the electrical energy storage device 1.

In order to be able to realize particularly advantageous, especially particularly safe, operation of the electrical energy storage device 1, a foam 11, which is, for example, in the form of a polyurethane foam, is arranged in the receiving space 3. By means of the foam 11, the storage cells 4, in particular the cell housing 5, are connected to each other, in particular glued together. For this purpose, for example, the foam 11 is arranged, in particular directly, in contact with a respective outer circumferential sheath surface 12 of the respective cell housing 5. In the case of the exemplary embodiment shown in the figures, the respective storage cell 4 is in the form of a respective round cell, which is cylindrical on the outer circumference. This means that the respective outer circumferential sheath surface 12 is in particular at least predominantly cylindrical on the outer circumference side in a predominant sub-area. In addition, it may be provided that the respective storage cell 4, in particular the respective cell housing 5, is connected, in particular glued, to the storage housing 2 by means of the foam 11. In a method for the production of the energy storage device 1, for example, the foam 11, especially in the liquid state of the foam 11, is introduced into the receiving space 3. The foam 11 can, during and/or after it has been introduced into the receiving space 3, foam up and thereby connect the cell housings 5 together and/or connect the respective cell housing 5 to the storage housing 2.

The respective connecting element 9 has a respective fuse 13. If, for example, there is a malfunction of one of the storage cells 4, wherein the malfunction is or includes, for example, a thermal event of the one storage cell 4, such a high electric current, also known as a residual current, flows through the connecting element 9 assigned to the terminal element 6 of a storage cell 4 and thus through the fuse 13 of the connecting element 9 which is assigned to the terminal element 6 of the storage cell 4 that has the malfunction, that the fuse 13 melts and thus fails, i.e. trips. As a result, the one storage cell 4 is separated, in particular electrically or galvanically, from the other, remaining and still intact storage cells 4 so that, for example, an encroachment of the thermal event from the one storage cell 4 to the other, still intact storage cells 4, and thus a thermal propagation, can be avoided.

For example, in order to be able to separate the respective storage cell 4 from the respective remaining storage cells 4 if such a defect occurs in the respective storage cell 4 that the defect of the storage cell 4 is or includes a medium-impedance failure, wherein, for example, the medium-impedance failure leads to a thermal event or includes a thermal event, a respective boundary element 14 formed separately from the storage cells 4, separately from the connecting device 8 and separately from the storage housing 2 is assigned to the respective fuse 13. The boundary elements 14 are constituent parts of a component or are formed by a component, which is also referred to as a unit and is designated as 15 in FIG. 1. For example, the boundary elements 14 are formed separately from each other and connected to each other, whereby the boundary elements 14 form the component 15, or the boundary elements 14 are formed with each other in one piece, i.e. formed from a single part, whereby the boundary elements 14 form the component 15. For example, the component 15 is a plate, which is also referred to as a load distribution plate.

The respective boundary element 14 assigned to the respective fuse 13 bounds a respective volume V, in particular directly, wherein the respective volume V in the present case is bounded partly by the respective boundary element 14 and partly by the storage housing 2, in particular by the housing part 10 and most particularly by an inner circumferential sheath surface 16 of the housing part 10, in each case directly. Since the respective boundary element 14 is assigned to the respective fuse 13, the respective volume V bounded by the respective boundary element 14 is assigned to the respective fuse 13. It can be seen from FIG. 1 that the respective fuse 13 is overlapped, in particular completely, by the volume V assigned to the respective fuse 13 on a respective side S2 facing away from the respective cell housing 5 and also referred to as the fuse side, and thereby in the direction of extension (arrow 7) towards the storage housing 2, in particular towards the housing part 10, wherein the respective volume V is free of the foam 11. As a result, the respective fuse 13 is particularly advantageously thermally decoupled or insulated from the foam 11 and from the storage housing 2, in particular from the housing part 10, so that excessive heat dissipation from the respective fuse 13 can be avoided. In addition, it can be seen from FIG. 1 that the respective terminal element 6 is overlapped by the respective volume V, at least partly, in particular at least predominantly and thus at least more than half or even completely, on a side S3, also referred to as the connection side or element side, facing away from the respective cell housing 5 and facing the respective fuse 13 and thereby in particular in the direction of extension towards the storage housing 2, in particular towards the housing part 10, so that particularly advantageous thermal insulation can be realized. For example, the respective volume V is, in particular completely, filled with air.

It can be seen that the respective boundary element 14 is a protrusion, also referred to as a knob or bulge, which extends directly from the housing part 10 and in particular directly to the sub-areas TB of the component 15 in contact with the boundary element 14 in a direction indicated by an arrow 16 that is opposite to the extension direction and in particular towards the respective assigned fuse 13. In particular, the sub-areas TB are connected, in particular directly, to the housing part 10, in particular glued, whereby the component 15 or the respective boundary element 14 is connected to the housing part 10 in a particularly advantageous way.

It can be seen from FIG. 1 that the respective boundary element 14 is glued to the housing part 10 by means of a first glue 17, in particular such that the respective sub-area TB is glued to the housing part 10 by means of the glue 17, in particular directly. The glue 17 forms a respective glue bond between the housing part 10 and the respective boundary element 14, wherein this glue connection is foam-tight, so that the foam 11, when it is introduced into the receiving space 3, cannot penetrate between the housing part 10 and the respective boundary element 14 and penetrate into the volume V.

The respective boundary element 14 has a respective side S4, also referred to as the boundary side, facing the respective fuse 13, the respective connecting element 9 and the respective terminal element 6, wherein in the present case the side S4 is glued directly to the connecting element 9 and in particular to the fuse 13 by means of a second glue 18. Preferably, the glue 18 is the same glue as the glue 17. It can be seen that no other further component is arranged between the connecting element 9 and the terminal element 6, and with the exception of the glue 18, no other further component is arranged between the side S4 and the connecting element 9 or the fuse 13. This ensures particularly advantageous thermal insulation.

For example, the respective storage cell 4 has a second terminal element, which is, for example, the respective cell housing 5. For example, the respective second terminal element forms an electrical negative pole. A respective second connecting element 19 is assigned to the respective second terminal element and is electrically and preferably also mechanically connected to the respective second terminal element.

### LIST OF REFERENCE SIGNS

1 Electrical energy storage device
2 Storage housing
3 Receiving space
4 Storage cell
5 Cell Housing
6 Terminal element
7 Arrow
8 Connecting device
9 Connecting element
10 Housing part
11 Foam
12 Outer circumferential sheath surface
13 Fuse
14 Boundary Element
15 Component
16 Arrow
17 Glue
18 Glue
19 Connecting element
S1 Side
S2 Side
S3 Side
S4 Side
TB Sub-area
V Volume

1.-10. (canceled)

11. An electrical energy storage device for a motor vehicle, comprising:
a storage housing bounding a receiving space;
storage cells arranged in the receiving space and designed for storage of electrical energy, each of which has a cell housing and at least one terminal element, to which is assigned a respective connecting element of a connecting device arranged in the receiving space,
wherein the connecting element assigned to the respective terminal element has a fuse and is electrically connected to the respective terminal element, whereby terminal elements are electrically connected to each other via the connecting device;
a foam arranged in the receiving space, by which the storage cells are connected to each other and/or to the storage housing; and
a boundary element, to which the fuse of the respective connecting element assigned to the respective terminal element is assigned, arranged in the receiving space,
wherein a respective volume is bounded by the boundary element, and the fuse is overlapped on a side facing away from the cell housing by the boundary element, wherein the respective volume is free of the foam.

12. The electrical energy storage device according to claim 11, wherein
the respective volume is filled with a medium, which has a lower thermal conductivity and/or a lower thermal capacity compared to the foam.

13. The electrical energy storage device according to claim 12, wherein the medium is a gas.

14. The electrical energy storage device according to claim 13, wherein the gas is air.

15. The electrical energy storage device according to claim 11, wherein
boundary elements are formed separately from the storage housing and are connected to the storage housing.

16. The electrical energy storage device according to claim 15, wherein
the boundary elements are connected to each other or are formed in one-piece with each other.

17. The electrical energy storage device according to claim 11, wherein
the respective terminal element, to which the connecting element having the respective fuse is assigned, is at least partially overlapped by the respective volume on a side facing away from the cell housing and facing the respective fuse of the connecting element assigned to the respective terminal element.

18. The electrical energy storage device according to claim 11, wherein
a side of the boundary element assigned to the fuse of the connecting element and facing the connecting element is directly connected to the connecting element.

19. The electrical energy storage device according to claim 18, wherein
the side of the boundary element is glued directly to the respective connecting element via a glue which is different from the foam.

20. A motor vehicle comprising at least one electrical energy storage device according to claim 11.
